(19) United States
(12) Patent Application Publication
(10) Pub. No.: US 2005/0274830 A1
(43) Pub. Date: Dec. 15, 2005

(54) Quick strike pneumatic pressure regulator

(76) Inventors: Daniel Gilmore, Aguanga, CA (US); Eric Petty, Aguanga, CA (US); Jerry Sullivan, San Dimas, CA (US)

Correspondence Address: BUHLER ASSOCIATES;BUHLER, KIRK A., 1101 CALIFORNIA AVE., SUITE 208, CORONA, CA, 92881, US

(21) Appl. No.: 10/866,598

(22) Filed: Jun. 14, 2004

(51) Int. Cl. B05B 9/08; A62C 15/00; B05B 9/03; A62C 13/66; B05B 7/32; F23D 11/24; F23D 14/28; B05B 1/30

(52) U.S. Cl. 239/569; 239/302; 239/337

(57) ABSTRACT

The invention relates to a belt mounted portable pneumatic pressure regulator where a CO2, compressed tank, or similar pressurized canister can be connected to the pressure regulator on one side and a hose can be connected to the other side of the regulator. The hose provides a regulated supply of pneumatic air for an air driven power tool, paint gun, or other piece of equipment that operates from a supply of pressurized air. The regulator may include a pressure gauge, adjusting knob, and a pressure relief or burst valve.

### FIELD OF THE INVENTION

The present invention relates generally to a portable pneumatic pressure regulator. More specifically, it relates to a belt or waist mounted pneumatic pressure regulator where a CO₂ or compressed air can be connected to the pressure regulator on one side and a hose can be connected to the other side of the regulator. The hose provides a regulated supply of pressurized gas or air to an air driven power tool, paint, gun, or other piece of equipment that operates from a supply of pressurizes gas or air.

### BACKGROUND OF THE INVENTION

Many pressure regulator inventions of this type are used to reduce the pressure from a tank of compressed gas or liquid gas. Most of these inventions are used where the pressurized tank is not transportable, or the tank is installed onto or within the equipment that uses the compressed gas. Other pressure regulators are used for SCUBA, life saving or apparatus where the regulator is located at the mouth of the user or at the tank. Other regulators may be used to regulate combustible gasses used for heating, welding or welding purposes. One of the major problems with pressure regulators of this type is that the regulator is not portable, or the tank is too large or heavy to be carried with the user.

U.S. Pat. No. 4,186,735 issued to Henneman el al. and U.S. Pat. No. 4,449,524 issued to Gray are regulators attached to respiratory equipment. These patents are intended for use with underwater breathing equipment. The regulators are located at the compressed air tank. While these patents allow for a pressure regulator that is attached to the compressed air tank, the patents are not intended for use with pneumatic tools, nor are they intended for use outside of water. The regulator is also not intended for mounting on the belt of the user.

U.S. Pat. No. 5,515,930 issued to Glasser discloses a pressure regulator that is intended for use with handheld pneumatic power tools. This patent uses a regulator located at a compressed air source. The regulated pressure is fed to a foot controlled flow regulator. After the foot controlled flow regulator, the air then flows into a pneumatic power tool. While this patent allows for a pressure regulator that is attached to the compressed air tank and controls a pneumatic power tool, the regulator is not intended to be mounted on the belt. The patent also uses a foot-operated pedal to control the flow to the pneumatic power tool.

U.S. Pat. No. 4,434,939 issued to Stankowitz, discloses a pressure regulator that is mounted to a pressurized tank that provides regulated air to texture a wall or ceiling. The regulated tank is intended to remain stationary as the user is tethered with a hose to pneumatically powered equipment. While this patent is intended for use with a pneumatic tool, the regulator is not intended to be mounted on the users belt. The regulator and air tank are not intended to be carried by the user as the user operates the pneumatic powered tool.

U.S. Pat. No. 4,211,352 issued to Zilka, disclose a pressure regulator located within a nailing machine. The compressed air tank, and pressure regulator are enclosed within the nailing machine. The user must hold the weight of the regulator, compressed air tank and the nailing machine. The weight of these components increases the fatigue factor as the operator uses the nailing machine. While this patent allows the pressure regulator to be included with the pressurized tank, the invention is not intended for mounting on the belt of a user.

None of the pressure regulators disclosed are intended to be mounted on the belt of the user, and provide a regulated pressure for use with pneumatic tools or equipment.

### BRIEF SUMMARY OF THE INVENTION

It is an objective of the present invention to provide a portable pressure regulator for use with pneumatic operated equipment. The pressure regulator is designed for mounting on the belt of a user. The regulator includes a coupling mechanism for attaching a tank of compressed air. This configuration of pressure regulator provides a number of advantages to systems that are currently available.

Compressed air is the only power source for a number of pieces of equipment, including nail guns, paint sprayers, texturing equipment and pneumatic automotive tools such as drills, grinders, wrenches, and tire fillers. These pieces of equipment require a regulated supply of compressed gas or air to operate. The supply of compressed air is currently supplied by either a long hose connected to a stationary pressure regulator, or by a supply of compressed air that is integrated within the equipment. The proposed invention provides a superior arrangement for supplying the regulated supply to the equipment by allowing the user to clip the regulator and compressed air to their belt.

With the regulator attached to the users belt, a canister of compressed air is connected or threaded into the regulator. The regulator swivels on the belt of the user to ensure that the canister remains in an upright configuration. The upright configuration allows the canister to only supply gas and not liquid gas to the regulator. Because the regulator is connected to the user's belt the weight of the regulator and canister is not held in the user's hand. The belt clip may be permanently attached, or could be attached to a removable device that allows the user to disconnect the regulator from the belt to change canisters. A hose is connected or threaded into a second connection on the regulator. The hose supplies a regulated supply from the canister.

The regulator may include an adjustment for the pressure. The pressure adjustment device allows the user to set or adjust the pressure in the hose. The pressure may require adjustment based upon the tool or equipment that is connected to the other end of the hose. The regulator may additionally include a pressure gauge to display the pressure in the hose. The pressure gauge allows the operator to visually see and set the pressure in the hose. If the user is torqueing nuts on a car they may require a higher pressure than a person air brushing the paint on a car. An additional component of the regulator may include a burp valve that allows the user to burp or bleed pressure from the hose prior to disconnecting a tool.

Another advantage of this invention is the pressure in the hose connected to the pneumatic tool is lower. The lower pressure in the hose is safer should a leak or break take place in the hose. This is a safer design as opposed to attaching the regulator to the pneumatic equipment and filling the hose with high-pressure air.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a perspective view of the invention connected to an air hose.

FIG. 2 is a cross sectional view of the invention showing the internal components.

FIG. 3 is a view of the invention and the belt-mounting device.

### DETAILED DESCRIPTION OF THE INVENTION

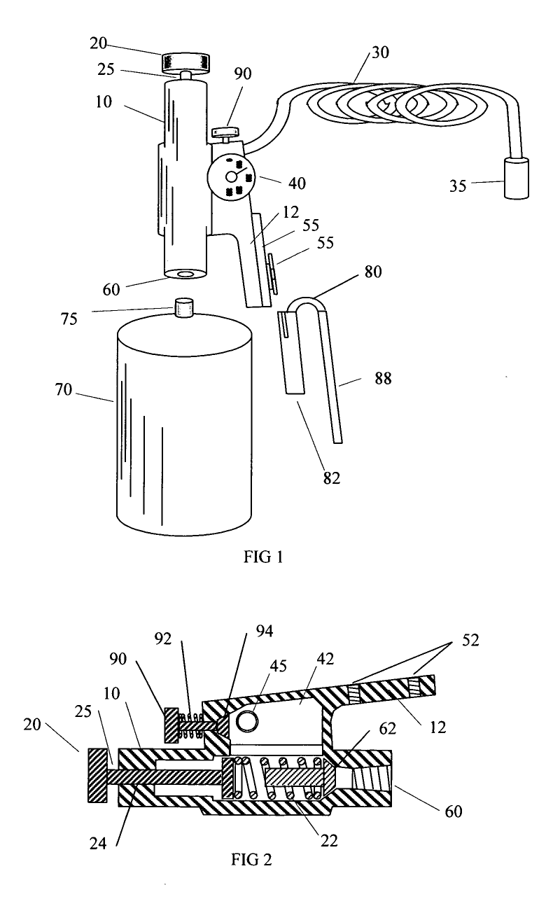

Referring first to FIG. 1, that shows a perspective view of the invention connected to an air hose, item 10, is the regulator. The regulator in the preferred embodiment is made from an aluminum body. On one end of the regulator a pressure adjustment knob, item 20, is located. The pressure adjustment knob allows the operator to change or set the pressure on the output side of the pressure regulator. The pressure adjustment knob is knurled on one side to allow the operator to grip the knob. The under side of the knob threads into the pressure regulator, item 25. As the knob is turned and threads into the regulator body the pressure can be increased or decreased. The pressure being set can be viewed on the pressure gauge, item 40. In the preferred embodiment the pressure regulator includes the pressure gauge. The pressure gauge and regulator can be manufactured in different pressure ranges. If the pressure regulator is intended for use with a nailing gun, the output pressure range may be 100 to 300 psi. In the preferred embodiment, the pressure is nominally 200 psi. If the pressure regulator is intended for use with a paint sprayer, the output pressure range may be 2 to 20 psi. In addition to manufacturing the pressure regulator with an adjustable pressure range the pressure regulator may be manufactured with a fixed pressure set by the manufacturer or requiring a special tool to make the adjustment. In the preferred embodiment, the pressure regulator is manufactured with an adjustable pressure range, where the adjustment can be preformed without a tool. On the side of the regulator opposite the pressure gauge, a connection for a hose is located. The connection can be a threaded connection or a quick release connection. The connection allows attachment of the pneumatic tool or a hose to be attached. In FIG. 1, a self-coiling hose, item 30 is shown. The hose allows the operator to use the pneumatic tool without motion restrictions. A self-coiling hose is preferred because the hose retracts and is not as susceptible to knotting or kinking as might occur with a straight hose. The hose may also be a rigid or stiff hose that help keeps the pneumatic tool in a semi-fixed orientation. At the end of the hose, a connector, item 35, is attached that allows the pneumatic tool to be connected or disconnected. In the preferred embodiment, the connector is a quick disconnect so the pneumatic tool or tools can be changed quickly. A quick disconnect is any variety of connectors that allows the tool to be disconnected from the hose without tooling and the hose can remain pressurized. The pressure regulator has an extended member, item 12, which extends from the regulator body.

On one side of the extended member, an attachment mechanism is screwed into the extended member. The attachment has a raised “D”, shaped feature connected to the extended member, item 54. The raised “D” shaped member allows engagement with a belt clip, item 80. The “D” shaped member engages in the belt clip in the area identified by item 82. To engage the “D” shaped member into belt clip, the regulator is rotated 90 degrees so the narrow part of the “D” shape can slide into the belt clip. Once the “D” shaped member is fully engaged into the clip, the regulator is rotated into a vertical orientation and the regulator locks into the belt clip. The belt clip is intended for placement over the belt, pants or pocket of an operator. The belt clip wraps around the belt with item 88. The clip can be a variety of shapes and configurations including a spring clip, or a “U” shaped piece of bent metal. The configuration and material used to make the belt clip requires only that the belt clip can remain on the users belt as the user moves unrestricted to perform their job. Item 70, is a compressed air, CO₂ or non-flammable pressurized canister. The canister can be filled with a variety of gasses from compressed air to liquid gas that is expandable. The canister may also include multiple elements, that when mixed, expand. On at least one side or end of the canister a connection mechanism, item 75 is located. The coupling or connection mechanism is designed to engage into the end of the pressure regulator at item 60. In the preferred embodiment, the connection mechanism is a threaded coupling that threads into the regulator. As the canister threads into the regulator, the regulator depresses a seal in the canister that allows a flow of pressurized air to enter the regulator. Item 90 is an optional secondary burst or pressure relief valve that allows the operator to release pressure in the hose. This burst valve can be operated by pressing, lifting or turning the valve. This valve is used when the connection to the pneumatic tool does not allow the hose to remain pressurized when the tool is disconnected. The operator sets the pressure to zero, and then activates the relief valve to relieve pressure within the hose. The tool can then be removed without pressure in the hose.

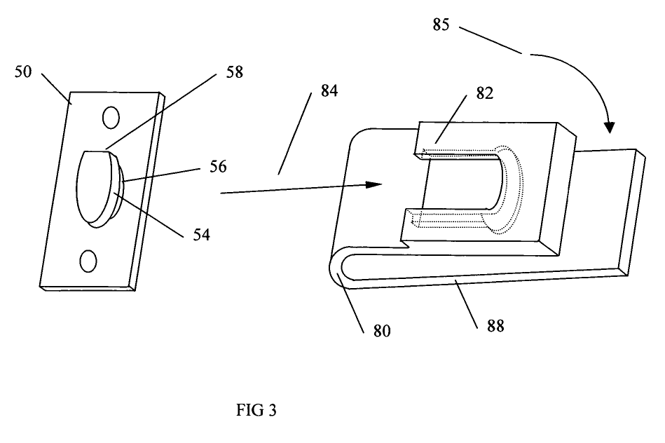

Referring now to FIG. 2 that show a cross section of an embodiment of the regulator, item 10. This cross sectional view is an embodiment of one particular design of a pressure regulator but various other types of pressure regulators are contemplated that can reduce the pressure from a high-pressure source to a lower pressure. The high-pressure source is connected into one side of the pressure regulator. In the embodiment shown, the high-pressure source is screwed into the regulator. On the opposite side of the regulator pressure adjustment mechanism, item 20 is located. In the embodiment shown the pressure adjustment device is shown on the opposite side from the high-pressure source connection, but the location of the pressure adjustment device can be located on any side of the regulator the allows adjustment of the regulated pressure. On the under side of the pressure adjustment device, is a threaded rod, item 25, that threads into the body of the regulator, item 24. As the pressure adjustment device is threaded in and out of the body of the regulator, the pressure adjustment device compresses a spring, item 22. The spring applies pressure to the sealing rod, item 62 located on the end where the high-pressure supply is attached, item 60. The sealing rod biases against the regulator housing to control the pressure differential between the pressurized air and the pressure in the regulator chamber, item 42. The pressure within the regulator is available at the coupling connection of the hose at item 45, and at a hole on the other side of the regulator body where the pressure gauge is located. An optional opening into the regulator chamber allows for venting the pressure in the regulator housing and hose at item 94. The vent is held closed by pressure in the regulator housing and by a spring, item 92. The vent is opened by depressing button 90. An extended arm on the pressure regulator housing has two threaded connection holes, item 52 where a connection mechanism can be affixed to allow the regulator to be removed from the belt attachment device.

Referring now to FIG. 3 that show an embodiment of the invention and the belt-coupling or mounting device. In FIG. 3, the attachment mechanism is shown upside down to provide better clarity of the features. One part of the belt attachment device, item 50, is attached to the regulator body by threading screws through the attachment device and into the regulator. The attachment device consists of a raised area, item 56. On top of the raised area is a generally flat undercut raised semi-circular shaped feature, item 54, with a flat, item 58, giving the part an appearance of a “D” shape. The belt clip, item 80, is shown in FIG. 3 located to the right of the attachment mechanism. Arrow, item 84, shows the motion of moving the attachment mechanism into the belt clip, item 82 and arrow 85, shows rotation of the attachment device in the belt clip to lock the attachment device into the belt clip. When the “D” shaped member is seated and rotated into the belt clip, the “D” shape maintains the attachment device in the belt clip while the pressure regulator is in a vertical or near vertical orientation. The belt clip is bent over, item 88, to allow the belt clip to remain connected to a belt, waistband or pocket.

Thus, specific embodiments and applications of a belt mountable pressure regulator have been disclosed. It should be apparent, however, to those skilled in the art that many more modifications besides those described are possible without departing from the inventive concepts herein. The inventive subject matter, therefore, is not to be restricted except in the spirit of the appended claims.

1. A portable pneumatic regulation system comprising:
a pneumatic pressure regulator;
a first coupling on the pneumatic pressure regulator for a compressed pneumatic tank;
a second coupling on the pneumatic pressure regulator wherein regulated pressure is available, and;
a third coupling mechanism on the pneumatic pressure regulator for attaching the pneumatic pressure regulator to the belt of a user.

2. The pressure regulator in claim 1 wherein the pressure regulator also includes a pressure gauge.

3. The pressure regulator in claim 1 wherein the pressure regulator also includes a pressure adjustment mechanism.

4. The pressure regulator in claim 1 wherein the pressure regulator also includes a secondary burst valve.

5. The couplings from claim 1 wherein the coupling is selected from a group consisting of threaded and quick coupling.

6. The third coupling mechanism from claim 1, wherein the coupling mechanism is selected from a group consisting of a clip, cam, D shape, U shape, spring clip.

7. The decoupling mechanism from claim 1 wherein the decoupling mechanism allows the pressure regulator to rotate on the coupling mechanism.

8. A portable pneumatic regulation system comprising:
a portable non-combustible non-respiratory pressure regulator with;
a first coupling on the pressure regulator for a compressed tank;
a second coupling on the pressure regulator where regulated pressure is available, and;
an attachment mechanism for attaching the pressure regulator to the belt of a user.

9. The pressure regulator in claim 8 wherein the pressure regulator also includes a pressure gauge.

10. The pressure regulator in claim 8 wherein the pressure regulator also includes a secondary burst valve.

11. The couplings from claim 8 wherein the coupling is selected from a group consisting of threaded and quick coupling.

12. The decoupling mechanism from claim 8, wherein the decoupling mechanism is selected from a group consisting of a clip, cam, D shape, U shape, spring clip.

13. The decoupling mechanism from claim 8 wherein the decoupling mechanism allows the pressure regulator to rotate on the decoupling mechanism.

14. A pressure regulator comprising:
a pressure regulator for pneumatic tools with a first coupling on the pressure regulator for a compressed tank;
a second coupling on the pressure regulator where regulated pressure is available, and;
a coupling mechanism on the pneumatic pressure regulator for attaching the pressure regulator to the belt of a user.

15. The pressure regulator in claim 14 wherein the pressure regulator also includes a pressure gauge.

16. The pressure regulator in claim 14 wherein the pressure regulator also includes a secondary burst valve.

17. The couplings from claim 14 wherein the coupling is selected from a group consisting of threaded and quick coupling.

18. The decoupling mechanism from claim 14, wherein the decoupling mechanism is selected from a group consisting of a clip, cam, D shape, U shape, spring clip.

19. The decoupling mechanism from claim 14 wherein the decoupling mechanism allows the pressure regulator to rotate on the decoupling mechanism.

20. A pressure regulator in claim 14 wherein the pressure regulator also includes a pressure adjustment mechanism.
